(19) United States
(12) Patent Application Publication
(10) Pub. No.: US 2025/0239778 A1
(43) Pub. Date: Jul. 24, 2025

(54) Ka band monopulse array antenna with low sidelobe levels

(71) Applicant: VIETTEL GROUP, Ha Noi City (VN)

(72) Inventors: NHU THAI LE, Dong Son District (VN); HOAI SON NGUYEN, Ha Noi City (VN); THI HANG LE, Ha Noi City (VN)

(73) Assignee: VIETTEL GROUP, Ha Noi City (VN)

(21) Appl. No.: 18/901,277

(22) Filed: Sep. 30, 2024

(30) Foreign Application Priority Data
Jan. 23, 2024 (VN) 1-2024-00544

(51) Int. Cl. H01Q 9/30; H01Q 21/06; H01Q 25/02

(52) U.S. Cl. CPC H01Q 9/30; H01Q 21/061; H01Q 25/02

(57) ABSTRACT

A Ka band monopulse antenna system with a compact size (diameter: 160 mm; height: 25 mm). The monopulse antenna system consists of a monopulse comparator; an unequal power divider and an array of 448 radiating slot antenna elements. The research results of the invention are as follows: the antenna operates in the Ka band frequency range; the realized gain at the center frequency is 34.2 dBi; the sidelobe level of the sum beam on the two E and H planes is less than −25 dB; the difference between the two peaks of the beams on the difference beam is small (about 0.1 dB); the peak-null difference of the difference beam is greater than 43 dB.

### TECHNICAL FIELD COVERED

The invention relates to Ka band antenna system of a monopulse radar system widely used in target tracking applications, the system having low side-lobe levels. Specifically, the system mentioned in the invention is applied in civil and military radars for the purpose of tracking targets of ground devices and aircraft, suitable for small-sized devices.

### BACKGROUND OF THE INVENTION

Among the published documents, articles and patents, some works have content related to monopulse antenna systems using slot antenna arrays. However, the related articles and patents have designs and operating principles different from the present disclosure or still have some shortcomings or limitations, specifically as follows:

The paper DOI: 10.1109/APCAP.2014.6992455 “Design of Low Sidelobe Slotted Waveguide Monopulse Antenna Array” at the 2014 3rd Asia-Pacific Conference on Antennas and Propagation, presents the design of a slot array antenna with the power division principle on a waveguide using radiation slots and the standing wave principle in the waveguide. The design principle, structure and form of the antenna system are completely different from the present invention.

The paper DOI 10.1109/TIE.2016.2608769 “Highly-Efficient Self-Compact Monopulse Antenna System with Integrated Comparator Network for RF Industrial Applications” published in IEEE in 2016 presents the design of a monopulse antenna system using a uniform power divider to each element for a square-shaped slot array with a large side-lobe gain (−13 dB). The structure and design of the antenna system are completely different from the present invention.

The Korean patent KR101461129B1 “Metal waveguide slot array for w-band millimeter-wave seeker and antenna therefor and method of manufacturing the array” in 2013 presents the design of a flat slot array antenna with a power divider on a waveguide using radiation slots and a standing wave principle in a waveguide. The design principle, structure and form of the antenna system are completely different from the present invention.

China's patent CN115377703B “K-waveband multi-layer feed monopulse array antenna” of 2022 describes a design of a circular monopulse slot array antenna on a using a ridge gap waveguide to each element with VSWR<1.5 and the difference between the two peaks of the difference beam is greater than 1 dB. The design principle, structure and appearance of the transmission line antenna system are completely different from the present invention.

To overcome the above limitations, the author proposes a two-channel single-pulse slot array antenna system using a multi-layer unequal power divider operating on the Ka band with low side-lobe level, the difference between the two peaks of the difference beam is small (≤0.2 dB), unlike any other invention that has ever been published.

### Technical Nature of the Invention

The purpose of the invention is to describe in detail the design of a Ka band monopulse slot array antenna system using a multi-layer unequal power divider with low side-lobe levels.

In which, Ka band is the radio frequency range from 26.5-40 GHz with wavelength from 1.1 cm to 0.75 cm.

The side lobes are all lobes in the antenna directional pattern except the main lobe in the energy radiation direction (in the present invention, the direction perpendicular to the forward face of the antenna).

To achieve the above purpose, the author proposes to design a antenna system using a two-channel monopulse comparator (1) to create a sum channel and two difference channels, using a multi-stage unequal power divider (2,3,4,5) according to the Taylor distribution suitable for the circular antenna array profile (6) to reduce the level of side lobes, using radiation slots (4) to the resonant cavity (5) and radiating through the radiating antenna slot array (6). The antenna system is compactly designed with a diameter of 160 mm and a height of 25 mm, suitable for placement in narrow spaces. In addition, the parts in each component are also shown in detail as follows:

The two-channel single-pulse comparator (1) consists of: four T-magic units (7), four port (12) connected to four power dividers (2), one sum port (8), two difference ports (9,10) and one matching load port (11).

Multi-stage unequal power divider (2,3,4,5) includes: four three-port output unequal power dividers (2) in the first stage using waveguide converter (13), T-junction on H-plane (14) and three output ports (15); the second stage of the power divider each quarter of the power divider uses T-junction on H-plane (14) with three input ports (15) from the first stage (2) and twenty-eight output ports (16); the third stage of the power divider (4) includes radiation slots (17) from the output ports (16) of the second stage (3) to the four-division resonant cavities (18) of the fourth stage (5).

The slot antenna array (6) consists of 448 radiating slots (19) arranged corresponding to the 448 output ports on the fourth stage (5) of the power divider.

### BRIEF DESCRIPTION OF THE DRAWINGS

FIG. 1 is a schematic diagram of the antenna system;

FIG. 2 is a detailed structural breakdown of the antenna system viewed from the front;

FIG. 3 is a detailed structural breakdown of the antenna system viewed from the back;

FIG. 4 is a drawing illustrating the structure of a two-channel monopulse comparator at the first stage of the antenna system;

FIG. 5 is a drawing illustrating the partial structure of the unequal power divider at the second stage position of the antenna system;

FIG. 6 is a drawing illustrating the partial structure of the unequal power divider at the third stage position of the antenna system;

FIG. 7 is a drawing depicting the structure of the radiation slots of the unequal power divider at the fourth stage position of the antenna system;

FIG. 8 is a drawing depicting the structure of the four-divided resonant cavities of the uneven power divider at the fifth stage position of the antenna system;

FIG. 9 is a schematic illustration of a 448-slot circular profile antenna array;

FIG. 10 shows the simulation results of the VSWR;

FIG. 11 depicts the three-dimensional (3D) radiation pattern of the sum port;

FIG. 12 depicts the three-dimensional (3D) radiation pattern of the difference port on the H-plane;

FIG. 13 depicts the three-dimensional (3D) radiation pattern of the difference port on the E-plane;

FIG. 14 depicts the 1D radiation pattern of the sum port on the H-plane;

FIG. 15 depicts the 1D radiation pattern of the sum port on the E-plane;

FIG. 16 depicts the 1D radiation pattern of the difference port on the H-plane; and

FIG. 17 depicts the 1D radiation pattern of the difference port on the E-plane.

### DETAILED DESCRIPTION OF THE INVENTION

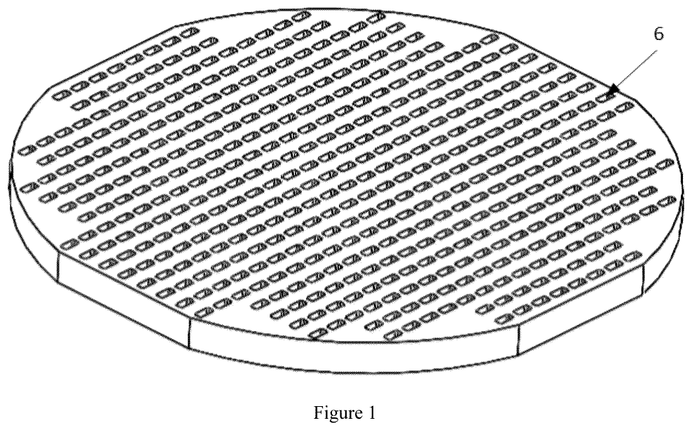

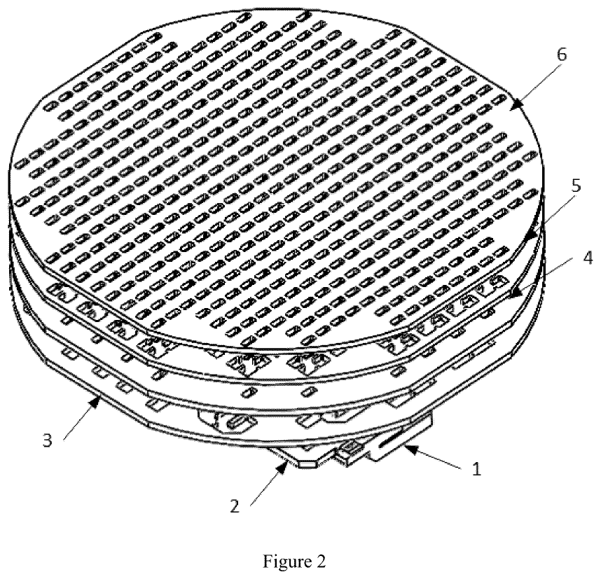

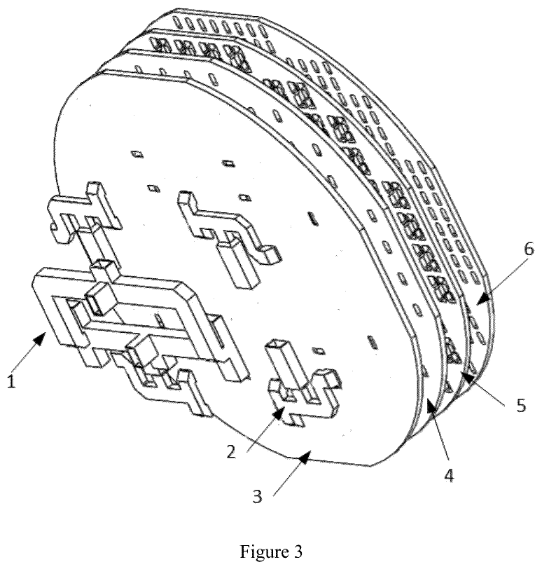

FIG. 1 shows an overview of the antenna system as a whole system, FIG. 2 shows and lists the components as a decomposition of the antenna system viewed from the front, FIG. 3 shows and lists the components as a decomposition of the antenna system viewed from the back.

Referring to FIGS. 1, 2, and 3, it can be seen that the monopulse antenna system consists of three main parts: the comparator; the unequal power divider, and the slot antenna element array.

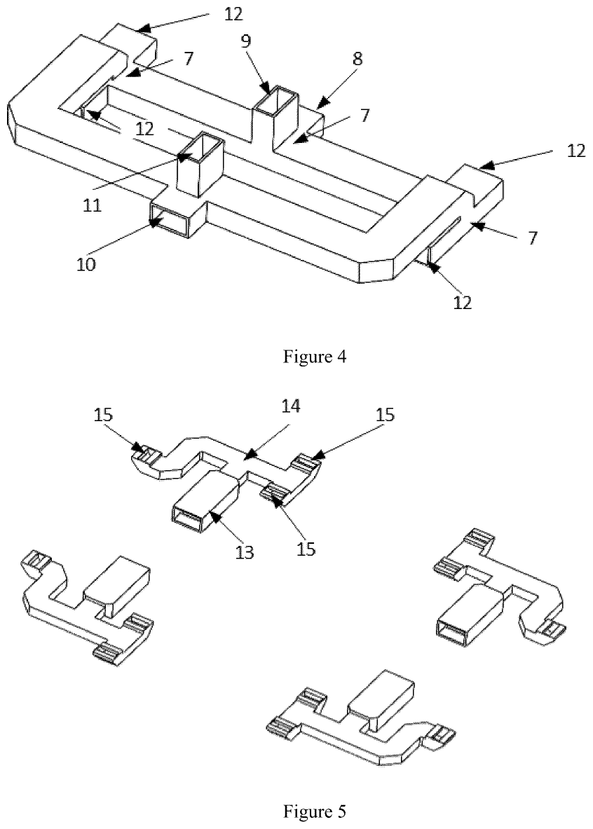

FIG. 4 shows the detailed structure of a two-channel monopulse comparator 1 using four T-magics on the E and H planes 7 with impedance matching. The four T-magics on the E and H planes 7 connected as shown in FIG. 4 will obtain a total of eight signal ports including: four input signal ports 12 connected to four component arrays of the slot antenna array; one sum port 8 (sum of four signals from four component antenna arrays); three difference ports 9,10,11 (difference of the sum of each two component antenna arrays on the E, H planes and the 45-degree diagonal plane);

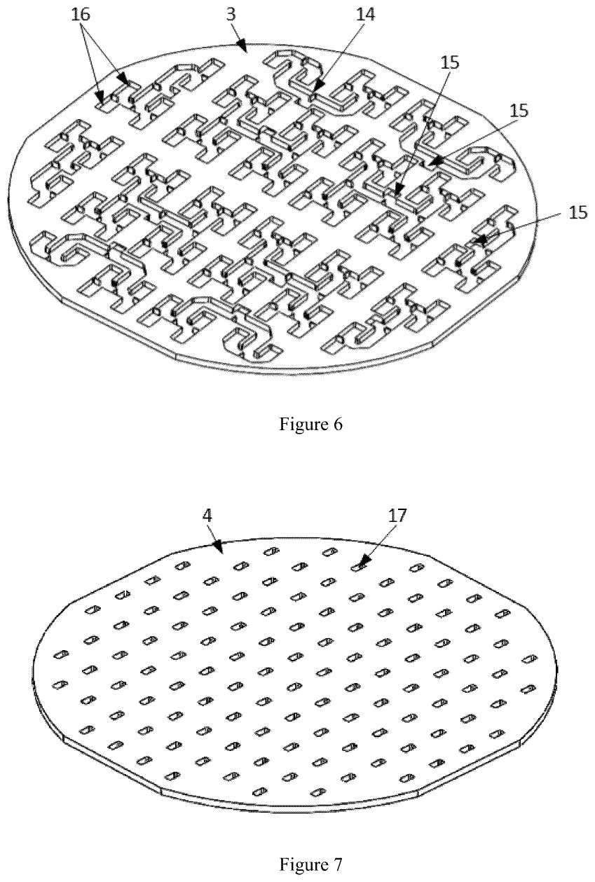

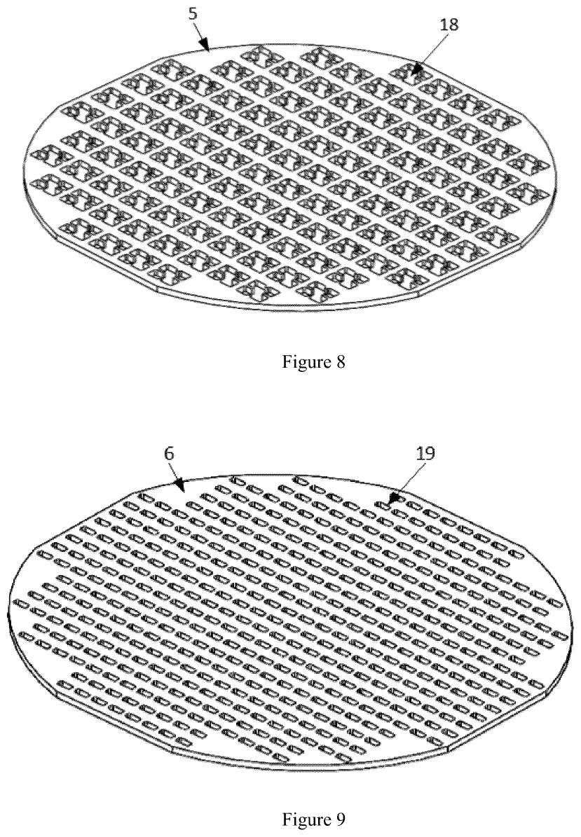

FIG. 5, FIG. 6, FIG. 7, FIG. 8 depict the four stages of the unequal power divider according to the Taylor distribution (SLL=20 dB,n=4) with the structure of the power divider suitable for the circular profile antenna array. Due to the priority of compact antenna design to limit the layout space, the power divider uses a rectangular waveguide with dimensions (5×2 mm). In which:

FIG. 5 illustrates the structure of a first-stage unequal power divider consisting of four identical 2-power dividers with one input port 12 and three output ports 15 using T-junctions on the H-plane 14 with baffles for desired power adjustment and windows for impedance matching. The input of the four-port power dividers in the first stage additionally use waveguide converters 13.

FIG. 6 shows the second stage of the unequal power divider using T-junctions on the H-plane similar to the first stage but with more splits resulting in 112 output ports on the second stage of the power divider.

The first and second stages of the power dividers are connected using a 90-degree angled waveguide 15.

FIG. 7 illustrates the third stage of the unequal power divider consisting of 112 radiation slots 17 used to connect the second and fourth stages of the power divider.

FIG. 8 shows the fourth stage of the unequal power divider consisting of 112 sets of four-division resonant cavities 18. Here, the signal after being radiated from the second stage through the radiation slots 17 on the third stage will be divided into four at the four-division resonant cavity 18.

FIG. 9 shows an array of 448 radiating slot antenna elements arranged in a circular profile corresponding to the output ports of the four-division resonant cavities 18.

Combining the components we get a very compact antenna system with a diameter of 160 mm and a height of 25 mm.

The components and details that make up the transmission line antenna system are using aluminum as design material with some typical features of aluminum such as: high durability, good electrical conductivity and light weight, suitable for arrangement on flying devices with high requirements in reducing the weight of the antenna system.

Conducting research and simulation of the overall monopulse mode antenna system, the following important results were obtained:

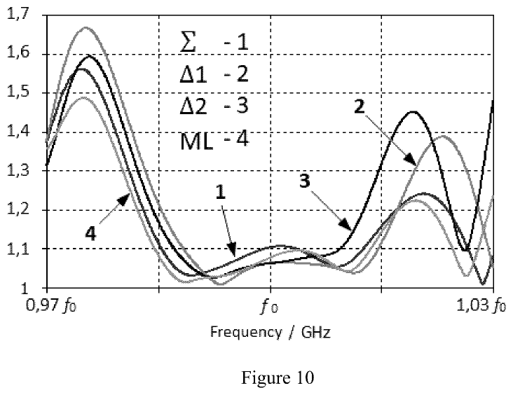

FIG. 10 shows the standing wave coefficient results according to frequency with the conventional center frequency f0. According to the results, we can evaluate that in the frequency range 0.98 f0-1.03 f0, the standing wave coefficient VSWR≤1.5 of all total and difference channels of the transmission line antenna system. Especially in the area around the center frequency f0, the standing wave coefficient reaches VSWR≤1.1.

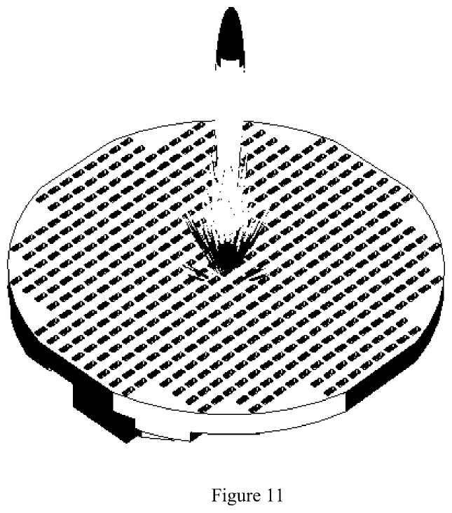

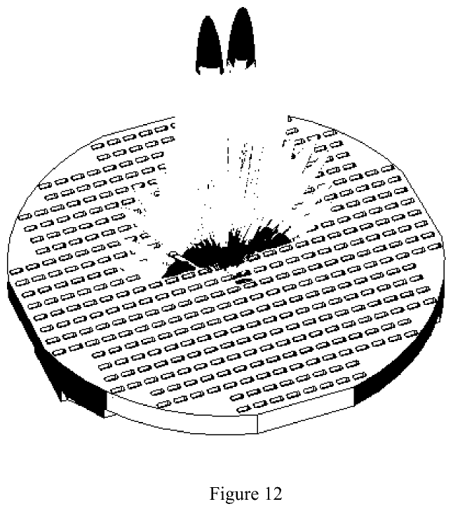

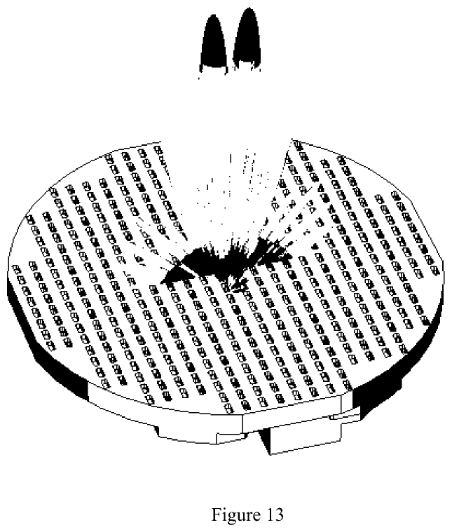

FIGS. 11, 12 and 13 show the three-dimensional (3D) radiation pattern of the sum port and the two difference port on the H and E planes of the center frequency f0, respectively.

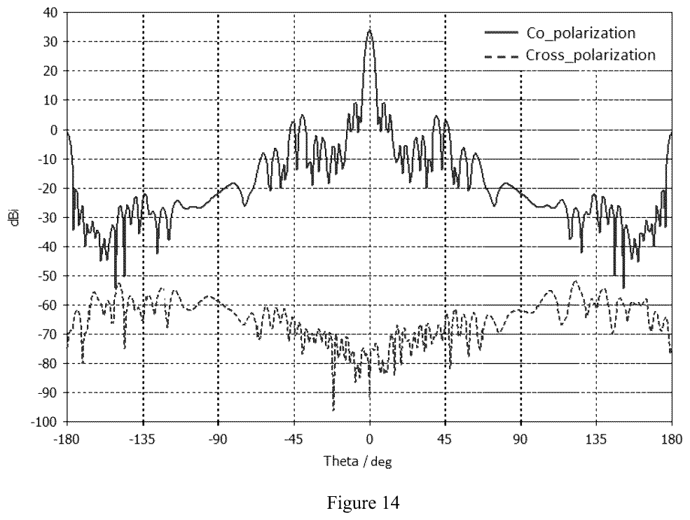

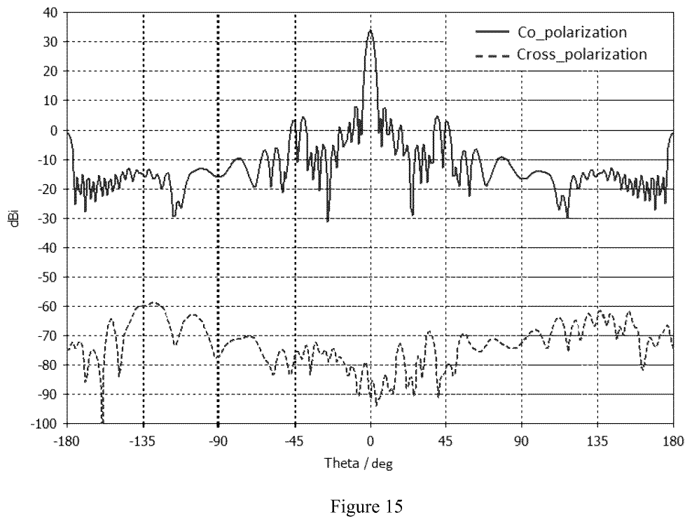

FIGS. 14 and 15 show the 1D radiation pattern of the sum port on the H and E planes of the center frequency f0, respectively. The results are obtained with a gain of about 34.2 dBi and a side-lobed level of about −26 dB.

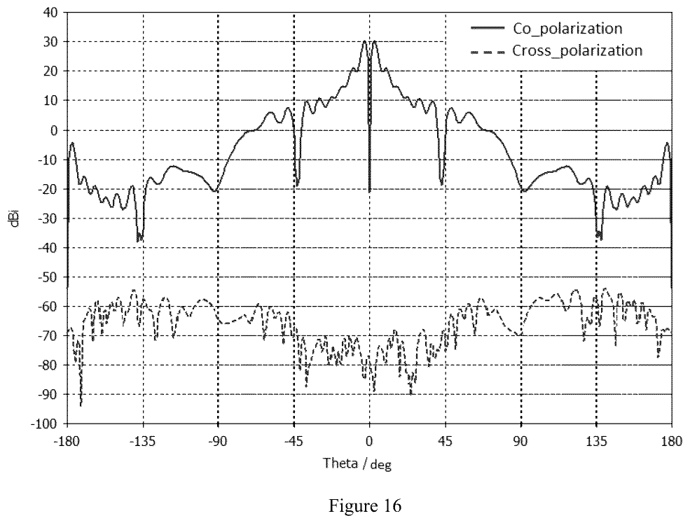

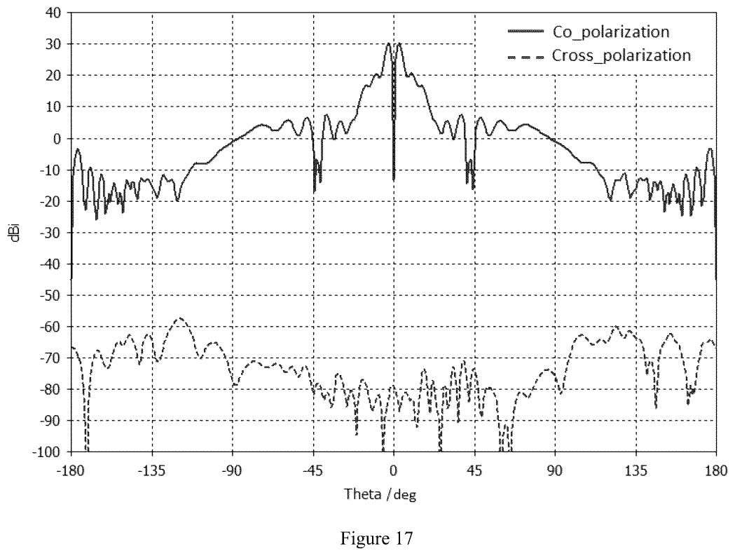

FIGS. 16 and 17 show the 1D radiation pattern of the two difference ports on the H and E planes of the center frequency f0, respectively. The results are obtained with a very small difference between the two peaks of the difference beams of about 0.1 dB and a peak-null difference greater than 43 dB.

1. A Ka-band monopulse antenna system with low side-lobe level including: a monopulse comparator; an unequal power divider and a slot antenna element array having four component subarrays; in which:
the monopulse comparator has two-channels and uses four T-magics on E and H planes with impedance matching and a WR28 standard waveguide; the four T-magics are combined on the E and H planes resulting in a total of eight signal ports: four input signal ports connected to the four component antenna subarrays of the slot antenna array; one sum port (a sum of four signals from the four component antenna subarrays); three difference ports (a difference of the sum of each of two component antenna subarrays on the E, H and 45-degree diagonal planes);
a Taylor distributed unequal power divider with a structure suitable for a circular profile antenna element array consisting of four stages; wherein to limit layout space, the power divider uses a rectangular waveguide; in which:
a first stage of the unequal power divider consists of four identical power splitters with one input port and three output ports using T-junctions on the H-plane with baffles for desired power adjustment and windows for impedance matching; the input ports of the three-port power divider on the first stage additionally use waveguide converters;
a second stage of the unequal power divider uses T-junctions on the H-plane similar to the first stage, wherein the number of splits is greater than the first stage, thereby obtaining 112 output ports on the second stage of the power divider;
a third stage of the unequal power divider includes 112 radiation slots used to connect the second stage and a fourth stage of the power divider;
the fourth stage of the unequal power divider consists of 112 sets of four-division resonant cavities; wherein the signal after being radiated from the second stage through the radiation slots on the third stage will be divided into four at the four-division resonant cavity;
the slot antenna element array consists of 448 radiating slot antenna elements arranged in a circular profile corresponding to output ports of the four-division resonant cavities; a 2×2 element antenna array is located in the antenna system; the 2×2 element antenna array is structured from the second stage of the unequal power divider to a 2×2 element radiating element array.

2. The Ka-band monopulse antenna system with low side-lobe level according to claim 1, wherein:
the first and second stages of the unequal power divider are connected using a 90-degree turn waveguide.

3. The Ka-band monopulse antenna system with low side-lobe level according to claim 1, wherein:
the WR28 standard waveguide comprises 7.112×3.556 mm.

4. The Ka-band monopulse antenna system with low side-lobe level according to claim 1, wherein:
the Taylor distributed unequal power divider comprises (SLL=20 dB,n=4).

5. The Ka-band monopulse antenna system with low side-lobe level according to claim 1, wherein:
the power divider uses a rectangular waveguide dimensions are (5×2 mm).
